(19) United States
(12) Patent Application Publication
(10) Pub. No.: US 2025/0379276 A1
(43) Pub. Date: Dec. 11, 2025

(54) SYSTEMS AND METHODS FOR COOLING A BATTERY

(71) Applicant: Toyota Motor Engineering & Manufacturing North America, Inc., Plano, TX (US)

(72) Inventors: Shailesh N. JOSHI, Ann Arbor, MI (US); Danny J. LOHAN, Northville, MI (US)

(73) Assignee: Toyota Motor Engineering & Manufacturing North America, Inc., Plano, TX (US)

(21) Appl. No.: 18/738,657

(22) Filed: Jun. 10, 2024

(51) Int. Cl. H01M 10/613; B60L 50/60; H01M 10/625; H01M 10/63; H01M 10/643; H01M 10/654; H01M 10/6568; H01M 50/213; H01M 50/249

(52) U.S. Cl. CPC H01M 10/613; B60L 50/60; H01M 10/625; H01M 10/63; H01M 10/643; H01M 10/654; H01M 10/6568; H01M 50/213; H01M 50/249; H01M 2220/20

(57) ABSTRACT

A battery cooling system may be configured for use with a battery. The battery may include a battery core. The battery cooling system may include a structured surface surrounding the battery core. The battery cooling system may include a plurality of wicking structures arranged axially around the structured surface. Each of the plurality of wicking structures may be arranged a distance apart from one another such that a space exists between each of the plurality of wicking structures. A battery case may surround the plurality of wicking structures.

### FIELD

The present disclosure relates to systems and methods for cooling a battery.

### TECHNICAL BACKGROUND

Batteries, such as those used for electric vehicles, may generate significant heat during operation which requires cooling in order to keep the batteries within their optimal operating temperature range. Conventional cooling systems can involve passing a cooling fluid along a battery cover to cool the battery core and maintain the battery core within its optimal operating temperature range.

### SUMMARY

Batteries, such as those used on electric vehicles, generate heat during operation. In order to operate effectively, batteries should be maintained within an ideal operating temperature range. Thus, batteries should be cooled. Oftentimes batteries may have a battery core surrounded by a battery cover. Cooling fluid may be pumped around the battery cover to cool the battery core. Conventional systems may pump a constant volume of fluid around the battery cover. This may create flow instability as the fluid boils and vapor is created around the battery cover. Further, this may create pressure drop along the length of the battery as the fluid travels further away from a pump moving fluid along the charging battery. Further, this may create uneven cooling along the battery. Therefore, there exists a need for a battery cooling system which can mitigate the flow instability, pressure drop, and uneven cooling with conventional charging cable cooling systems.

The present system can be a more efficient battery cooling system than conventional battery cooling systems by utilizing a structured surface which can wick cooling fluids towards battery with the wicks acting as capillaries, and the structured surfaces also forming escape paths for vaporized cooling fluid.

The system generally includes a battery including a battery core, a battery case, an outer surface, and a structured surfaces. A space or channels may be formed between the structured surfaces. Cooling fluid may be drawn through wicking structures in the structured surfaces. The cooling fluid may be vaporized by the heat generated by the battery core. The vaporized cooling fluid may be vented through the space or channels formed between the structured surfaces. The cooling fluid may be circulated through fluid feed lines or fluid feed pipes via a pump. The fluid may be cooled with a condenser or heat exchanger. This can provide the advantage of less pressure drop and more even temperature distribution along the battery compared to conventional battery cooler systems.

According to one embodiment, a battery cooling system may be configured for use with a battery. The battery may include a battery core. The battery cooling system may include a structured surface surrounding the battery core. The battery cooling system may include a plurality of wicking structures arranged axially around the structured surface. Each of the plurality of wicking structures may be arranged a distance apart from one another such that a space exists between each of the plurality of wicking structures. A battery case may surround the plurality of wicking structures.

According to another embodiment, a battery cooling system may be configured for use with a battery. The battery may include an outer surface and a battery core. The battery cooling system may include a plurality of wicking structures configured to be arranged axially around the outer surface of the battery. Each of the plurality of wicking structures may be arranged a distance apart from one another such that a channel exists between each of the plurality of wicking structures. A structured surface may be arranged around each of the plurality of wicking structures.

According to a further embodiment, a method for cooling a battery may include drawing a cooling fluid through a plurality of wicking structures. The plurality of wicking structures may be arranged axially around an outer surface of a battery cover. The plurality of wicking structures may be each spaced a distance apart from one another. The battery cover may surround a battery core. The cooling fluid may be heated by the battery core such that the cooling fluid becomes vaporized. The vaporized cooling fluid may be vented through a space between each of the plurality of wicking structures.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of the present disclosure may be better understood when read in conjunction with the following drawings in which:

FIG. 1 schematically depicts a section view of a battery core and battery cover according to one or more embodiments shown and described herein;

FIG. 2 schematically depicts a side view of a battery cooling system according to one or more embodiments shown and described herein;

FIG. 3 schematically depicts a section view of a battery core and battery cover according to one or more embodiments shown and described herein;

FIG. 4 schematically depicts a side view of a battery cooling system according to one or more embodiments shown and described herein;

FIG. 5 schematically depicts a battery cooling loop according to one or more embodiments shown and described herein; and

FIG. 6 schematically depicts a flowchart of a method for cooling a battery.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to a battery cooling system which provides for structures to pass a cooling fluid to remove heat from a battery core. The battery cooling system may include one or more structured surfaces which may wick cooling fluid towards the battery surface. The structured surface may wick the cooling fluid via the capillary effect. The cooling fluid may be vaporized by the heat from the battery core. The vaporized cooling fluid may be vented through spaces or channels formed between the one or more structured surfaces. The vaporized cooling fluid may be cooled via a condenser or heat exchanger, and re-circulated through the system. In other embodiments, the battery cooling system may have a pump, a valve, and a controller to control the flow of cooling fluid within the battery.

Conventional battery cooling systems may result in increased pressure drop inside of the battery as cooling fluid is pumped through the battery compared to the pressure drop of the present system. Embodiments can more evenly distribute cooling fluid within the battery compared to conventional cooling systems. The present system can also reduce pressure drop within the charger cable compared to conventional cooling systems.

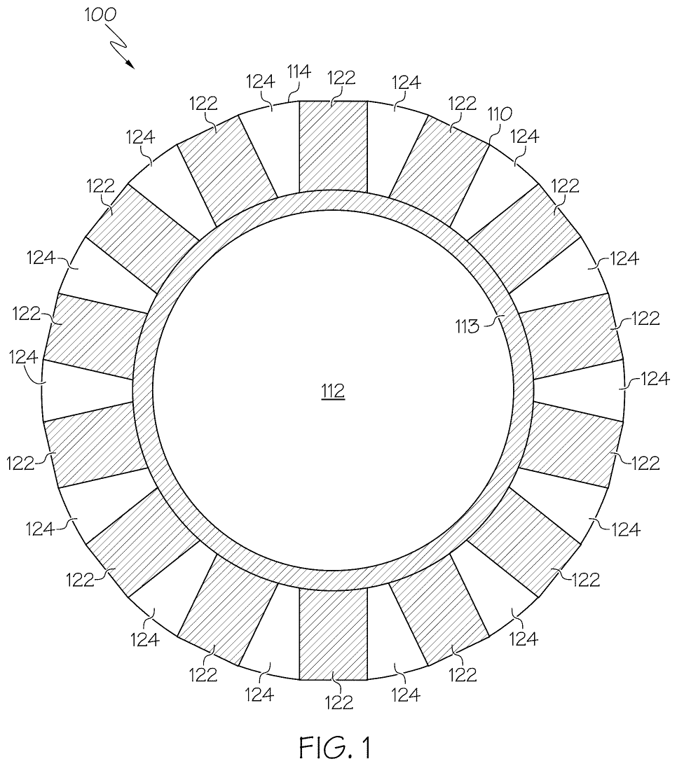

Referring now to FIG. 1, a cross section of a top view of a battery 110 with a battery cooling system 100 is shown. The battery 110 may be a lithium ion battery, a lithium cobalt oxide battery, a nickel-metal hydride battery, a solid-state battery, or any other suitable type of battery. In embodiments, the battery 110 may be configured for use in an electric vehicle, such as to power the drive motors. In other embodiments, the battery 110 may be configured for use in fuel cells, climate systems, and various other auxiliary components. The battery 110 has a battery core 112. The battery core 112 may house battery cells, battery acid, battery electrodes, or other suitable battery components.

A structured surface 113 encircles the battery core 112. The structured surface 113 may allow for the passage of a cooling liquid around the battery core 112 in order to cool the battery core 112. The structured surface 113 may be made of any suitable material, including but not limited to copper, aluminum, stainless steel, or any other suitable material.

Heat from the battery core 112 may vaporize some or all of the cooling liquid. The vaporized cooling liquid may be vented through the spaces 124 between the wicking structures 122, as will be described in more detail herein.

A plurality of wicking structures 122 are fluidly coupled to the structured surface 113. The plurality of wicking structures 122 may act as capillaries to wick cooling fluid towards the structured surface 113. The plurality of wicking structures 122 may be made of any suitable material, including but not limited to copper, aluminum, stainless steel, or any other suitable material. In some embodiments, the wicking structures 122 may be formed as one or more microchannels.

As illustrated, each of the plurality of wicking structures 122 are arranged axially around the structured surface 113, but it should be understood that the plurality of wicking structures 122 may be arranged in any other suitable arrangement.

In some embodiments, the structured surface 113 may include a porosity gradient, such that the structured surface 113 may wick a lower amount of cooling fluid nearer to the fluid reservoir 132 and wick a higher amount of cooling fluid nearer to the condenser 160.

The battery case 114 encircles the battery core 112, such that the battery case 114 surrounds the battery core 112. In some embodiments, the battery case 114 may only partially surround the battery core 112. The battery case 114 has an outer surface 116. The outer surface 116 may face away from the battery core 112. Each of the plurality of wicking structures 122 are spaced a distance apart from one another such that a space 124 exists between each of the plurality of wicking structures 122. The plurality of wicking structures 122 may be arranged axially around the battery core 112.

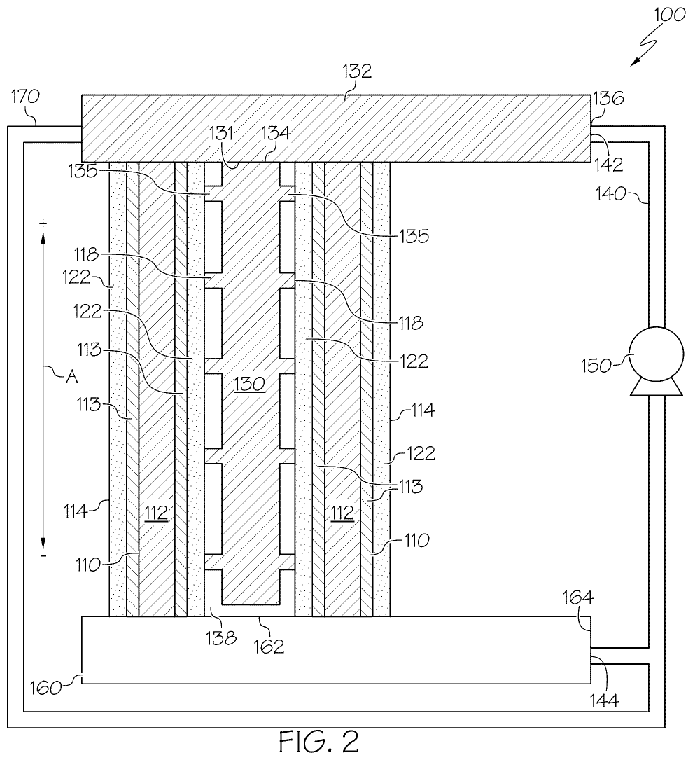

Referring now to FIG. 2, an embodiment of a side view of the battery cooling system 100 is shown. The battery cooling system 100 is configured for use with one or more batteries 110. As illustrated, the battery cooling system 100 is configured for use with two batteries 110, but it should be understood that in embodiments the battery cooling system 100 may be configured for use with any suitable number of batteries 110, such as one battery 110, four batteries 110, ten batteries 110, or any other suitable number of batteries.

The battery cooling system 100 may include a manifold 130. The manifold 130 may be shaped and sized to distribute cooling fluid. The manifold 130 may be constructed of any suitable material, including but not limited to plastic, steel, aluminum, copper, or any other suitable material. The manifold 130 may include a fluid inlet 131. The manifold 130 may include one or more fluid outlets 135.

The battery cooling system 100 may include a vapor space 138 between the one or more batteries 110. The manifold 130 may be disposed within the vapor space 138. The vapor space 138 may allow for vaporized cooling fluid to vent from the space 124 (shown above) through the vapor space 138.

The battery cooling system 100 may include a fluid reservoir 132. The fluid reservoir 132 may be shaped and sized to store a volume of cooling fluid. The cooling fluid may be without limitation, water, glycol-water solutions, dielectric fluid, or any other fluid suitable for cooling batteries. The fluid reservoir 132 may have a fluid inlet 136 and a fluid outlet 134. The fluid outlet 134 may be fluidly coupled to the fluid inlet 131 of the manifold 130. As illustrated, the fluid reservoir 132 may be placed vertically above the manifold 130 such that cooling fluid may flow downward from the fluid reservoir 132 to the manifold 130 by the force of gravity, where the positive direction of axis A represents vertically upward.

The battery cooling system 100 may include a fluid transfer pipe 140. The fluid transfer pipe 140 may include a fluid transfer pipe outlet 142 and a fluid transfer pipe inlet 144. The fluid transfer pipe outlet 142 may be fluidly coupled to the fluid reservoir 132 at the fluid inlet 136. In other embodiments, there may not be a fluid reservoir 132 such that the fluid transfer pipe 140 is fluidly coupled directly to the manifold 130.

The battery cooling system 100 may include a pump 150. The pump 150 may be fluidly coupled to the fluid transfer pipe 140. The pump 150 may be a positive-displacement pump, centrifugal pump, axial-flow pump, or any other suitable type of pump. In embodiments, the battery cooling system 100 may include more than one pump 150, such as two pumps 150, three pumps 150, five pumps 150, or any other suitable number of pumps 150.

The battery cooling system 100 may include a condenser 160. The condenser 160 may be configured to condense the vaporized cooling fluid of the battery cooling system 100. In embodiments, the condenser 160 may be any suitable type of condenser, including but not limited to an air-cooler condenser, a water-cooler condenser, an evaporative condenser, or any other suitable type of condenser. The condenser 160 may include a condenser inlet 162 and a condenser outlet 164.

The fluid transfer pipe 140 may be fluidly coupled to the condenser outlet 164 at the fluid transfer pipe inlet 144. The condenser 160 may be fluidly coupled to the vapor space 138 at a condenser inlet 162.

Cooling fluid may be pumped by the pump 150 through the fluid transfer pipe 140 to the fluid inlet 136 of the fluid reservoir 132. Cooling fluid may flow from the fluid reservoir 132 to the manifold 130. Cooling fluid may flow from the manifold 130 through the wicking structures 122 to the structured surface 113. The cooling fluid may be vaporized by heat from the battery core 112. Vaporized cooling fluid may be vented through the spaces 124.

The battery cooling system 100 may include a bypass line 170. The bypass line 170 may be fluidly coupled to the fluid reservoir 132 and the fluid transfer pipe 140. The bypass line 170 may allow a portion of the fluid to bypass the battery 110.

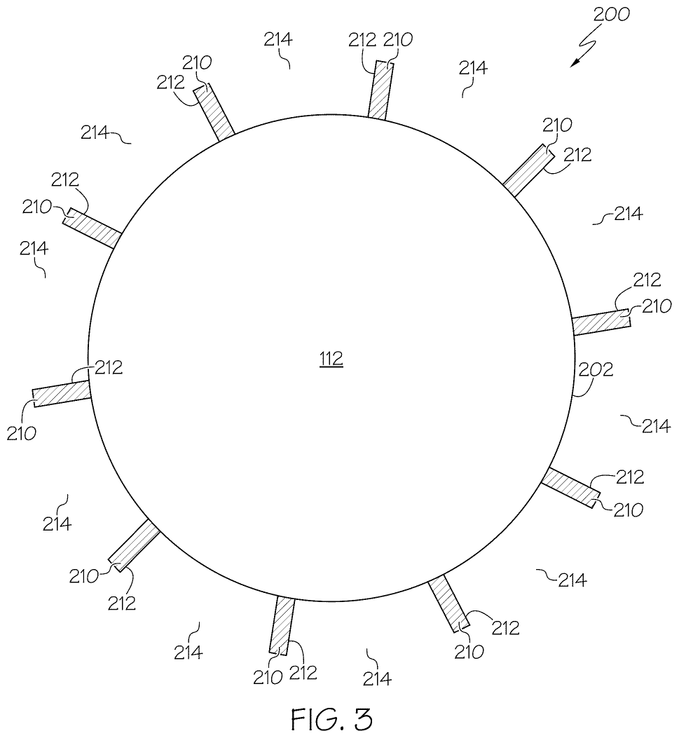

Referring now to FIG. 3, a cross section of a top view of a battery 110 with a battery cooling system 200 is shown. The battery cooling system 200 includes a plurality of wicking structures 210 arranged axially on an outer surface 202 of the battery 110. Each of the plurality of wicking structures 210 may protrude outward from the outer surface 202 of the battery 110. Each of the plurality of wicking structures 210 have a structured surface 212 arranged around the plurality of wicking structures 210. The structured surfaces 212 may be made of one or more porous walls, which may allow the structured surface 212 to act as capillaries to draw cooling fluid through the plurality of wicking structures 210. In some embodiments, the wicking structures 210 may be formed as one or more microchannels.

The structured surface 212 may have a porosity gradient, similar to that described above for the structured surface 113. By drawing cooling fluid through the plurality of wicking structures 210, heat from the battery 110 may be transferred to the cooling fluid. The heat from the battery 110 may vaporize the cooling fluid.

As illustrated, each of the plurality of wicking structures 210 has a rectangular cross-sectional shape, but it should be understood that in embodiments the plurality of wicking structures 210 may have any suitable cross-sectional shape, including but not limited to triangular, semi-circular, or any other suitable cross-sectional shape.

One or more channels 214 are formed between each of the plurality of wicking structures 210. The one or more channels 214 may allow for vaporized cooling fluid to vent away from the outer surface 202 of the battery 110.

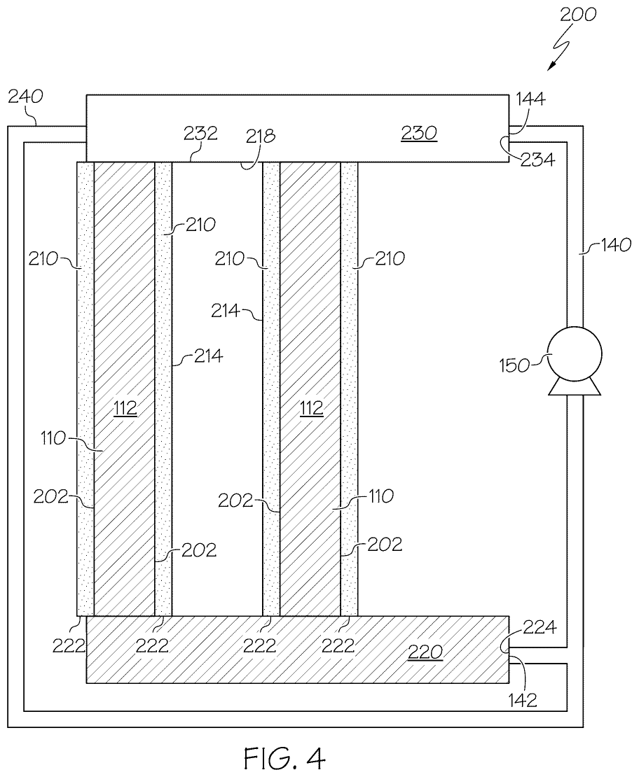

Referring now to FIG. 4, an embodiment of a side view of the battery cooling system 200 is shown. The battery cooling system 200 is configured for use with one or more batteries 110. As illustrated, the battery cooling system 100 is configured for use with two batteries 110, but it should be understood that in embodiments the battery cooling system 100 may be configured for use with any suitable number of batteries 110, such as one battery 110, four batteries 110, ten batteries 110, or any other suitable number of batteries 110.

The battery cooling system 200 may include a vapor space 216 between the one or more batteries 110. The vapor space 216 may allow for vaporized cooling fluid to vent from the channels 214 through the vapor space 216. The vapor space 216 may have a vapor space outlet 218.

The battery cooling system 200 may include a fluid feed line 220. The fluid feed line 220 may be arranged to allow an entry of cooling fluid into the battery cooling system 200. The fluid feed line 220 may have a fluid inlet 224. The fluid inlet 224 may be fluidly coupled to the fluid transfer pipe outlet 142.

The fluid feed line 220 may have one or more fluid outlets 222. Each of the one or more fluid outlets 222 may be fluidly coupled to each of the plurality of wicking structures 210. The one or more fluid outlets 222 may allow the plurality of wicking structures 210 to draw cooling fluid vertically upward along the batteries 110. The heat from the batteries 110 may vaporize the cooling fluid.

In embodiments not shown, the fluid feed line 220 may be fluidly coupled to a fluid source such as a fluid tank. In embodiments where the cooling fluid is water, the fluid feed line 220 may be fluidly coupled to a municipal water source.

The battery cooling system 200 may include a condenser 230. In embodiments, the condenser 230 may be any suitable type of condenser, including but not limited to an air-cooler condenser, a water-cooler condenser, an evaporative condenser, or any other suitable type of condenser. The condenser 230 may have a condenser inlet 232 and a condenser outlet 234. The condenser inlet 232 may be fluidly coupled to the vapor space outlet 218, such that vaporized cooling fluid may be transferred from the vapor space 216 to the condenser 230. The condenser outlet 234 may be fluidly coupled to the fluid transfer pipe 140. The pump 150 may flow cooling fluid to the fluid inlet 224.

The battery cooling system 200 may include a bypass line 240. The bypass line 240 may be fluidly coupled to the condenser 230 and the fluid transfer pipe 140. The bypass line 240 may allow a portion of the fluid to bypass the battery 110.

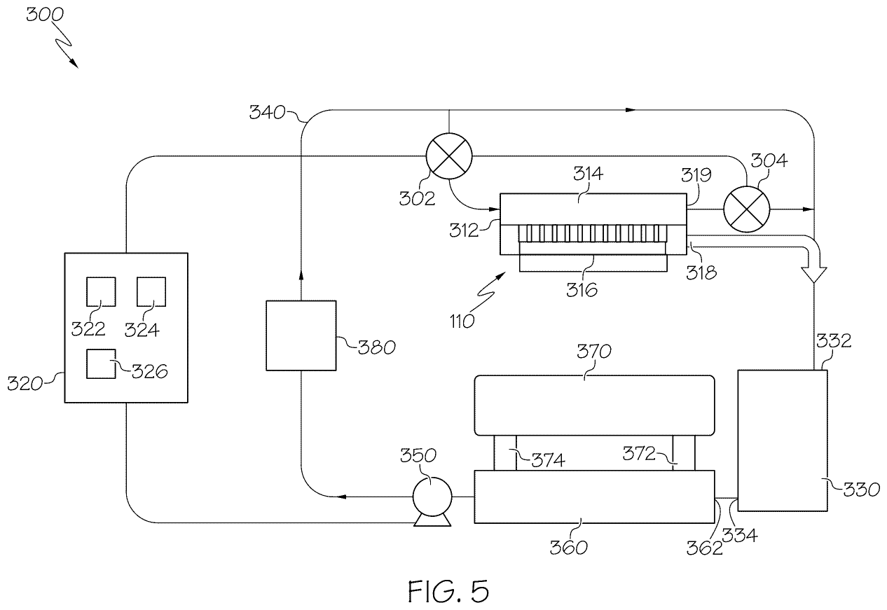

Referring now to FIG. 5, an embodiment of a side view of a battery cooling system 300 is shown. The battery cooling system 300 includes a fluid feed line 340. The fluid feed line 340 may be fluidly coupled to a fluid inlet 312 of a battery 110. The fluid inlet 312 may be fluidly coupled to a battery manifold 314. The battery manifold 314 may allow for the passage of cooling fluid from the fluid inlet 312 to the battery surface 316, such as through the embodiments described in any of FIGS. 1-4.

The battery manifold 314 is fluidly coupled to a fluid outlet 319. The fluid outlet 319 may allow for non-vaporized cooling fluid to be transported back to the fluid feed line 340.

A vapor outlet 318 may be coupled to the battery surface 316. The vapor outlet 318 may allow for vaporized cooling fluid to be transported back to the fluid feed line 340.

The battery cooling system 300 may include a pump 350. The pump 350 may be fluidly coupled to a fluid feed line 340. The pump 350 may be configured to transfer cooling fluid through the fluid feed line 340. The pump 350 may be any suitable type of pump, including but not limited to a positive-displacement pump, centrifugal pump, axial-flow pump, or any other suitable type of pump. In some embodiments, the pump 350 may be a variable speed pump.

The battery cooling system 300 may include one or more valves. As illustrated, the battery cooling system 300 includes a first valve 302 and a second valve 304. However, it should be understood that in embodiments, the battery cooling system 300 may include any suitable number of valves, including but not limited to one valve, three valves, five valves, or any other suitable number of valves.

The first valve 302 may be fluidly coupled to the fluid feed line 340. The second valve 304 may be fluidly coupled to the fluid outlet 319 of the battery manifold 314. The first valve 302 and the second valve 304 may be any suitable type of valve, including but not limited to a gate valve, a ball valve, a butterfly valve, a globe valve, or any other suitable type of valve.

In some embodiments, the first valve 302 and the second valve 304 may both be the same type of valve. In further embodiments, the first valve 302 and the second valve 304 may be different types of valves.

In some embodiments, the first valve 302 and/or the second valve 304 may be coupled to an electro-mechanical device such as a stepper motor to open and close the first valve 302 and/or the second valve 304. In other embodiments, the first valve 302 and/or the second valve 304 may have a manual handle to open and close the first valve 302 and/or the second valve 304.

The first valve 302 and/or the second valve 304 may be placed in various opening states, including but not limited to zero-percent open (completely closed), twenty-five-percent open, fifty-percent-open, or one-hundred-percent open.

The battery cooling system 300 may include a controller 320. The controller 320 may include a processor 322, a user interface 324, and a non-transitory, processor-readable storage medium 326. The non-transitory, processor-readable storage medium 326 may also be referred to as the memory of the controller 320. The user interface 324 may be for example a touch screen, a keypad, a mobile computing device, or any other suitable user interface.

The controller 320 may be communicatively coupled to the first valve 302, the second valve 304, and/or the pump 350. The controller 320 may be configured to send a signal to the first valve 302, the second valve 304, and/or the pump 350.

In embodiments, the controller 320 may send a signal to the first valve 302 and/or the second valve 304 to change the opening state of the first valve 302 and/or the second valve 304. As a non-limiting example, the controller 320 may send a signal to the first valve 302 and/or the second valve 304 to change from zero-percent open to one-hundred percent open. In further embodiments, the controller 320 may send a signal to the first valve 302 to change from zero-percent open to one-hundred percent open and the controller 320 may send a signal to the second valve 304 to change from one-hundred percent open to zero-percent open.

The first valve 302 and/or the second valve 304 may be used to control the flow of cooling fluid into and out of the battery 110.

In further embodiments, the controller 320 may send a signal to the pump 350. The signal may be to power on or power off the pump 350. In embodiments where the pump 350 is a variable speed pump, the signal may be to change the speed of the pump 350.

The battery cooling system 300 may include a tank 330. The tank 330 may include a fluid inlet 332 and a fluid outlet 334. The fluid inlet 332 and the fluid outlet 334 may be fluidly coupled to the fluid feed line 340. The tank 330 may be configured to hold a volume of cooling fluid therein, which may increase the overall cooling fluid capacity of battery cooling system 300.

The battery cooling system 300 may include a heat exchanger 360. The heat exchanger 360 may include a liquid inlet 362 and a liquid outlet 364. The heat exchanger 360 may be any suitable type of heat exchanger, including but not limited to an liquid-to-air heat exchanger or a liquid-to-liquid heat exchanger.

The heat exchanger 360 may be fluidly coupled to a cooling source 370. The cooling source 370 may include an inlet 372 and an outlet 374. The cooling source 370 may be, as a non-limiting example, a source of chilled water, chilled refrigerant, or chilled air which may be used as a cooling medium. The cooling medium may pass across the heat exchanger 360 to cool the cooling fluid.

The battery cooling system 300 may include an electronic device 380. The electronic device 380 may be fluidly coupled to the fluid feed line 340. The electronic device 380 may be, as a non-limiting example, a power converter, a battery charger, or a motor. The battery cooling system 300 may be used to cool the electronic device 380 in addition to the battery 110.

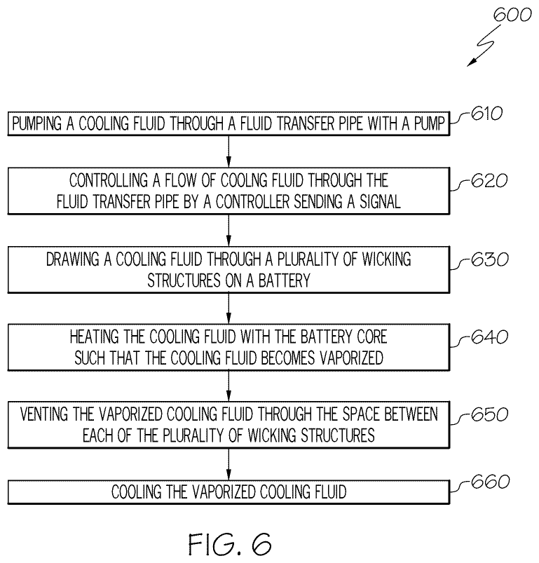

Referring now to FIG. 6, an illustration of a method 600 is illustrated with reference to FIGS. 1-5 consistent with a disclosed embodiment. The method 600 is directed at cooling a battery. At step 610, the method 600 includes pumping a cooling fluid through the fluid feed line 340 with the pump 350. That is, the pump 350 may be configured to circulate cooling fluid through the fluid feed line 340.

At step 620, the method 600 includes controlling the flow of cooling fluid through the fluid feed line 340 by the controller 320 sending a signal. That is, the controller 320 may send a signal to the pump 350, the first valve 302, and/or the second valve 304 to control the flow of cooling fluid through the fluid feed line 340. As a non-limiting example, the controller 320 may send a signal to activate the pump 350 and open the first valve 302 and the second valve 304.

At step 630, the method 600 includes drawing a cooling fluid through a plurality of wicking structures on the battery 110. That is, the cooling fluid may be drawn through the wicking structure 122 or the wicking structure 210 towards the battery 110.

At step 640, the method 600 includes heating the cooling fluid with the battery core 112 such that the cooling fluid becomes vaporized. That is, the heat from the battery core 112 may be transferred to the cooling fluid such that the cooling fluid becomes vaporized.

At step 650, the method 600 includes venting the vaporized cooling fluid through the space 124 or the vapor space 216. That is, the vaporized cooling fluid may be vented away from the battery 110.

At step 660, the method 600 includes cooling the vaporized cooling fluid. That is, the vaporized cooling fluid may be cooled with the condenser 160, the condenser 230, or the heat exchanger 360.

Accordingly embodiments of the present disclosure provide a battery cooling system which may more effectively control pressure drop and even cooling across the battery. Particularly, a battery cooling system may include one or more structured surfaces which may wick cooling fluid towards the battery surface. The structured surface may wick the cooling fluid via the capillary effect. The cooling fluid may be vaporized by the heat from the battery core. The vaporized cooling fluid may be vented through spaces or channels formed between the one or more structured surfaces. The vaporized cooling fluid may be cooled via a condenser or heat exchanger, and re-circulated through the system. In other embodiments, the battery cooling system may have a pump, a valve, and a controller to control the flow of cooling fluid within the battery.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A battery cooling system, the battery cooling system configured for use with a battery comprising a battery core and the battery cooling system comprising:
a structured surface surrounding the battery core;
a plurality of wicking structures arranged axially around the structured surface, each of the plurality of wicking structures arranged a distance apart from one another such that a space exists between each of the plurality of wicking structures; and
a battery case surrounding the plurality of wicking structures.

2. The battery cooling system of claim 1, further comprising:
a manifold, the manifold comprising a fluid inlet and one or more fluid outlets, wherein the one or more fluid outlets are fluidly coupled to the plurality of wicking structures;
a condenser, the condenser fluidly coupled to the space between each of the plurality of wicking structures and the condenser fluidly coupled to a fluid transfer pipe;
a pump fluidly coupled to the fluid transfer pipe; and
the fluid transfer pipe fluidly coupled to the manifold.

3. The battery cooling system of claim 2, wherein the battery cooling system is configured to be used with a plurality of batteries.

4. The battery cooling system of claim 2, further comprising a valve fluidly coupled to the fluid transfer pipe.

5. The battery cooling system of claim 4, further comprising a controller communicatively coupled to the valve and to the pump.

6. The battery cooling system of claim 2, further comprising one or more electronic devices fluidly coupled to the fluid transfer pipe.

7. The battery cooling system of claim 1, wherein the battery cooling system is arranged on an electric vehicle.

8. A battery cooling system, the battery cooling system configured for use with a battery comprising an outer surface and a battery core and the battery cooling system comprising:
a plurality of wicking structures configured to be arranged axially around the outer surface of the battery, each of the plurality of wicking structures arranged a distance apart from one another such that a channel exists between each of the plurality of wicking structures and a structured surface arranged around each of the plurality of wicking structures.

9. The battery cooling system of claim 8, wherein the structured surface further comprises a porosity gradient.

10. The battery cooling system of claim 8, further comprising:
a fluid transfer line;
a fluid feed line fluidly coupled to the fluid transfer line and the plurality of wicking structures;
a condenser fluidly coupled to the plurality of wicking structures and the fluid transfer line; and
a pump fluidly coupled to the fluid transfer line.

11. The battery cooling system of claim 10, further comprising a valve fluidly coupled to the fluid transfer pipe.

12. The battery cooling system of claim 11, further comprising a controller communicatively coupled to the valve and to the pump.

13. The battery cooling system of claim 10, further comprising one or more electronic devices fluidly coupled to the fluid transfer pipe.

14. The battery cooling system of claim 10, further comprising a fluid reservoir fluidly coupled to the fluid transfer pipe.

15. The battery cooling system of claim 8, wherein the battery cooling system is arranged on an electric vehicle.

16. A method for cooling a battery comprising the steps of:
drawing a cooling fluid through a plurality of wicking structures, wherein the plurality of wicking structures are arranged axially around an outer surface of a battery cover and are each spaced a distance apart from one another, and wherein the battery cover surrounds a battery core;
heating the cooling fluid with the battery core such that the cooling fluid becomes vaporized; and
venting the vaporized cooling fluid through a space between each of the plurality of wicking structures.

17. The method of claim 16, further comprising:
pumping the cooling fluid through a fluid feed line with a pump, the fluid feed line arranged to flow fluid to the battery and the pump fluidly coupled to the fluid transfer pipe.

18. The method of claim 17, further comprising:
one or more valves fluidly coupled to the fluid feed line; and
controlling a flow of cooling fluid through the fluid feed line by a controller sending a signal corresponding to at least one of the following:
(a) turn on or off the pump;
(b) change a speed of the pump; or
(c) change an open state of at least one of the one or more valves.

19. The method of claim 16, further comprising:
pumping the cooling fluid across one or more electronic components, the one or more electronic components fluidly coupled to the fluid feed line.

20. The method of claim 16, wherein the battery is arranged in an electric vehicle.
